(19) United States
(12) Patent Application Publication
(10) Pub. No.: US 2016/0149839 A1
(43) Pub. Date: May 26, 2016

(54) Multi-Network Chat System

(71) Applicant: Superchat, LLC, NY, NY (US)

(72) Inventors: Richard Yi, Phnom Penh (KH); Pliny Porter, Los Angeles, CA (US)

(21) Appl. No.: 14/947,498

(22) Filed: Nov. 20, 2015

Related U.S. Application Data
(60) Provisional application No. 62/082,565, filed on Nov. 20, 2014.

(51) Int. Cl. H04L 12/58; H04L 29/08

(52) U.S. Cl. CPC H04L 51/04; H04L 67/28; H04L 67/1095; H04L 67/306

(57) ABSTRACT

A network-based chat server provides a virtual chat room for chat participants, and synchronizes and shares chat dialogue exchanged between the chat participants regardless of whether the chat participants are logged onto the same chat platform or different chat platforms. The chat server includes a plurality of chat proxies; each of which is configured to communicate data with a particular chat platform. A chat synchronizer function executing at the chat server communicates the chat dialogue between the chat participants via the chat proxies.

### RELATED APPLICATIONS

The present disclosure claims priority from U.S. Provisional Application Ser. No. 62/082,565 filed Nov. 20, 2014, the entirety of which is incorporated herein by reference.

### TECHNICAL FIELD

The present disclosure relates generally to electronic messaging services, and more particularly to services that facilitate chat sessions across varying different chat networks.

### BACKGROUND

Social media services such as FACEBOOK, WHAT'SAPP, SKYPE, VIBER, and the like, are widely used and very popular. When logged into their respective accounts, users of these services are permitted to, inter alia, send and receive chat dialogue between them. Such dialogue includes, for example, text, images, video, and the like. However, conventional chat services are based on a few assumptions with respect to the users. The first assumption is that the two users wishing to communicate via chat messaging have an active account on the same chat service (e.g., both users have an active FACEBOOK account and can communicate messages with each other using FACEBOOK MESSENGER). The second assumption is that the users will log into their respective accounts, although not necessarily simultaneously, to retrieve a message and send a reply.

One problem frequently encountered by users is establishing chat sessions with other users who are not using the same chat network. For example, consider a situation where User A, who is currently logged onto his/her FACEBOOK account, wishes to establish a chat session with User B, who is logged into his/her WHAT'SAPP account. Conventionally, User A cannot establish a chat session with User B, unless one of those users logged into the chat network of the other user. For this to occur, however, one of the users would have to be aware that the other user was on-line and logged into their respective chat network. This information is not shared across disparate chat networks.

### SUMMARY

Embodiments of the present disclosure provide a chat system for synchronizing and sharing chat messages between client devices regardless of whether those devices are currently logged onto a same chat platform or different chat platforms.

More particularly, in one embodiment, the present disclosure provides a method for establishing a chat session between users on disparate chat platforms. The method is performed at a chat server computer and calls for receiving, from a host user, a request to establish a chat session with a first chat participant. The method also determines that the host user and the first chat participant are associated with disparate chat platforms, and selects a chat proxy for the first chat participant. The chat proxy that is selected for the first chat participant is configured to communicate with the chat platform associated with the first chat participant. The method then calls for sending and receiving chat dialogue between the host user and the first chat participant across the disparate chat platforms via the selected chat proxy.

In another embodiment, the present disclosure provides a chat server for establishing a chat session between users on disparate chat platforms. The chat server comprises a communications interface circuit and a processing circuit. The communications interface circuit is configured to communicate data with one or more client devices and one or more chat platforms. The processing circuit is configured to receive, from a host user, a request to establish a chat session with a first chat participant, determine that the host user and the first chat participant are associated with disparate chat platforms, select a chat proxy for the first chat participant, wherein the chat proxy is configured to communicate with the chat platform associated with the first chat participant, and send and receive chat dialogue between the host user and the first chat participant across the disparate chat platforms via the selected chat proxy.

In another embodiment, the present disclosure provides a computer-readable medium. Computer code is stored thereon that, when executed by a processing circuit of a chat server, controls the chat server to receive, from a host user, a request to establish a chat session with a first chat participant, determine that the host user and the first chat participant are associated with disparate chat platforms, select a chat proxy for the first chat participant, wherein the chat proxy is configured to communicate with the chat platform associated with the first chat participant, and send and receive chat dialogue between the host user and the first chat participant across the disparate chat platforms via the selected chat proxy.

Of course, those skilled in the art will appreciate that the present disclosure is not limited to the above contexts or examples, and will recognize additional features and advantages upon reading the following detailed description and upon viewing the accompanying drawings.

### BRIEF DESCRIPTION OF THE DRAWINGS

Exemplary embodiments of the present disclosure will become more fully apparent from the following description and appended claims, taken in conjunction with the accompanying drawings. It should be understood that the drawings illustrate only exemplary embodiments, and therefore, do not limit the scope of the disclosure. The exemplary embodiments of the invention will be described with additional specificity and detail through use of the accompanying drawings in which:

FIG. 1 illustrates a chat system 10 configured according to one embodiment of the present disclosure.

FIG. 2 is a functional block diagram illustrating a chat synchronizer configured to facilitate cross-platform chat sessions according to one embodiment of the present disclosure.

FIG. 3 illustrates an exemplary Host User Profile and the information it aggregates according to one embodiment of the present disclosure.

FIG. 4 is a functional block diagram illustrating a chat proxy interacting with a chat synchronizer and an external chat platform according to one embodiment of the present disclosure.

FIG. 5 is a signaling diagram illustrating a method for registering a user with the local chat platform according to one embodiment of the present disclosure.

FIGS. 6A-6B are flow diagram illustrating respective methods for routing chat messages between users of the same, and different, chat platforms, according to one embodiment of the present disclosure.

FIG. 7 is a perspective view showing exemplary client devices as a pair of smartphones.

FIG. 8 is a functional block diagram illustrating a chat system configured according to one embodiment that connects three different users, with each user being logged onto a different chat platform.

FIG. 9 is a functional block diagram illustrating some of the functional components of an exemplary chat server according to one embodiment of the present disclosure.

FIG. 10 is a block diagram illustrating some of the main functional components of exemplary processing circuitry at a chat server configured according to one embodiment of the present disclosure.

FIG. 11 illustrates an exemplary computer program product embodying computer program code that is executed by the processing circuitry of chat server according to one embodiment of the present disclosure.

### DETAILED DESCRIPTION

In the following description, it is to be understood that such terms as “forward,” “rearward,” “front,” “back,” “right,” “left,” “upwardly,” “downwardly,” and the like are words of convenience and are not to be construed as limiting terms.

Embodiments of the present disclosure provide a chat system that synchronizes and shares chat dialogue between clients regardless of whether they are currently logged onto the same chat network or different chat networks. By way of example only, such chat networks (also referred to herein as “chat platforms”) may comprise any of a number of known applications and social media platforms (e.g., FACEBOOK, SKYPE, WHAT'S APP, VIBER, etc.) that allow chat messaging between their users.

Because of the variety and number of different chat platforms that are available, users can, and typically are, logged onto different chat platforms at different times. Thus, users who are currently logged onto one chat platform may not always know when other users are on-line. This makes it difficult, at times, for users to establish a desired chat dialogue with other users. The embodiments described herein, however, address such “online opaqueness” across disparate chat platforms and provides a single platform that allows users to chat with each other regardless of whether they are logged onto the same chat network, or onto different chat networks.

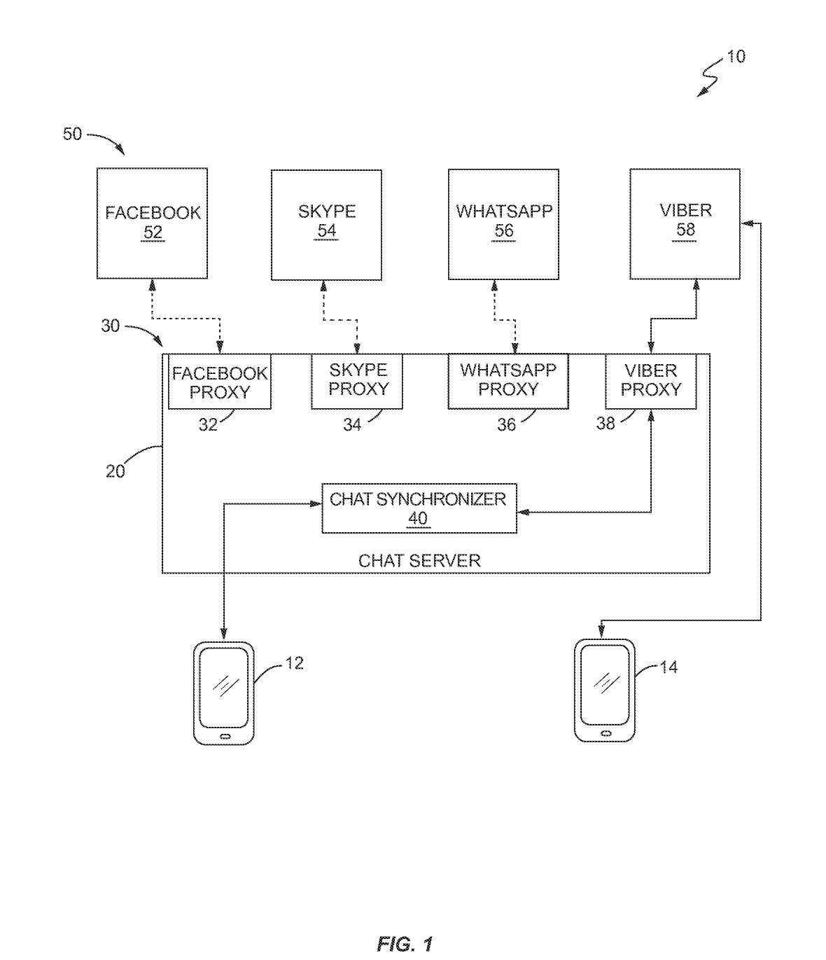

Turning now to the drawings, FIG. 1 illustrates a system 10 configured according to one embodiment of the present disclosure. Those of ordinary skill in the art will readily appreciate that the particular components seen in FIG. 1 are for illustrative purposes only, and that chat system 10 may comprise more, fewer, or different components than those seen in FIG. 1 as needed or desired.

System 10 comprises a chat server 20 that communicatively interconnects a pair of client devices 12, 14 to a plurality of different chat platforms 50. While not specifically shown in the figures, the chat server 20, the client devices 12, 14, and the chat platforms 50 are connected via one or more public and/or private communications networks, as is known in the art. Such networks may comprise, for example, the Internet or other such IP network capable of communicating information in data packets, any of a variety of wireless communications networks, or any combination thereof.

Each client device 12, 14 is associated with a corresponding user and may comprise any hardware communications device known in the art. Generally, each client device 12, 14 is capable of allowing a user to communicate chat dialogue with other users via one or more of the chat platforms 50, and includes devices such as cellular telephones (e.g., smartphones), laptop and notebook computing devices, tablet computing devices, desktop computing devices, smartwatches, and the like. To facilitate chat communications between users, each client device 12, 14 executes a user-level application that corresponds to the particular chat platform 50. Thus, if the users of client devices 12, 14 have a FACEBOOK account, the chat applications executing on client devices 12, 14 would include a FACEBOOK user application. Similarly, if the user of client devices 12, 14 have a WHAT'SAPP account, the client applications executing on client devices 12, 14 would include a WHAT'SAPP user application. Of course, each client device 12, 14 may execute the same or different user applications depending on which chat platforms 50 the user(s) are associated with.

The chat platforms 50, as stated above, may comprise any of a variety of commonly-known platforms (e.g., social media platforms) on which the users of client devices 12, 14 have an account. Such chat platforms 50 include, but are not limited to, those hosted by one or more computer servers 52 associated with FACEBOOK (hereinafter, “FACEBOOK 52”), one or more computer servers 54 associated with SKYPE (hereinafter, “SKYPE 54”), one or more computer servers 56 associated with WHAT'SAPP (hereinafter, WHAT'SAPP 56″), and one or more computer servers 58 associated with VIBER (hereinafter, “VIBER 58”). As is known in the art, each chat platform 50 may comprise its own proprietary chat service to effect chat communications between users, and may not be communicatively compatible with the chat services of the other chat platforms 50.

Chat server 20 is configured to facilitate the chat communications between the users of corresponding client devices 12, 14. In some embodiments, chat server 20 is configured to provide a “local” chat platform for users of the client devices 12, 14. If the users are registered with the chat server 20, the users of client devices 12, 14 may establish a chat dialogue using the “local” chat service provided by the “local” chat platform. However, the present disclosure does not require users to be registered with the chat server 20 in order to participate in a chat session. In some cases, one or more of the users may only have a registered user account with one or more of the other chat platforms 50. In these situations, chat server 20 is configured to “bridge” the “local” chat platform and the various chat platforms 50 to allow the users of client devices 12, 14 to communicate via a chat session even though the client devices 12, 14 may be currently logged onto different chat platforms.

To facilitate such cross-platform chat communications, chat server 20 comprises a plurality of chat proxies 30 and a chat synchronizer 40. Each chat proxy 30 is unique and corresponds to a particular chat platform 50. In the embodiment of FIG. 1, for example, there are four chat proxies 30—a FACEBOOK proxy 32, a SKYPE proxy 34, a WHAT'S APP proxy 36, and a VIBER proxy 48. Further, each chat proxy 30 functions as a valid, active user on its corresponding chat network 50. For example, consider a situation where the user of client device 12 has an active FACEBOOK account. As described later in more detail, FACEBOOK proxy 32 is configured to obtain the logon credentials of that user (e.g., Username and Password), and use those credentials to log onto the user's FACEBOOK account as the user of client device 12. Once the FACEBOOK proxy 32 is logged onto the FACEBOOK account, chat messages may be sent by client server 20 via FACEBOOK proxy 32 to other FACEBOOK users on behalf of the user of client device 12 as if the user of client device 12 was actually logged onto his/her FACEBOOK account.

Those of ordinary skill in the art should appreciate, however, that the present disclosure does not require the chat proxies 30 to log onto a corresponding chat platform 50 as the user of a client device 12, 14. In other embodiments, which are described later in more detail, the chat proxies 30 have their own independent accounts on the corresponding chat platforms 50 that are distinct from the user's accounts on those platforms. By way of example only, FACEBOOK proxy 32 could have its own Username/Password combination for logging onto its own active FACEBOOK account. In these cases, FACEBOOK proxy 32 would log onto its FACEBOOK account as itself, rather than as the user of client device 12, and send the chat messages to other FACEBOOK users on behalf of the user of client device 12. Additionally, the chat messages sent to the other FACEBOOK users according to this embodiment may be modified by the chat server 20 to make it appear as if the user of client device 12 had actually sent the chat message, or at least to identify the user of client device 12 as being the source of the chat message.

In some embodiments, the chat proxies 30 may be configured to log onto their corresponding accounts on chat platforms 50 both as an independent user, as well as a particular user associated with client device 12 (or another device). However, regardless of the particular method used by the chat proxies 30 to log onto their corresponding chat platforms 50, each individual chat proxy 30 communicates with its corresponding chat platform 50 as if it were an actual, active user.

As will be seen in more detail later, each chat proxy 30 comprises hardware circuitry, or a combination of hardware circuitry and software. All chat proxies 30 are associated with the chat server 20, and none are integrated into any of client applications executing on the client devices 12, 14. Nor are any of the chat proxies 30 visible to any of the users of the chat platforms 50. Rather, as seen in FIG. 1, the chat proxies 30 are all integrated into the chat server 20. However, those of ordinary skill in the art should appreciate that integrating the functionality of the chat proxies 30 into the chat server 20 is illustrative of only some embodiments. In other embodiments, one or more of the chat proxies 30 are distributed across one or more other network-based server computing devices (e.g., other chat servers 20) communicatively connected to the chat server 20.

As stated above, chat server 20 also comprises a chat synchronizer 40. The chat synchronizer 40, which also comprises hardware circuitry, or a combination of hardware circuitry and software, provides services and functions that are used across all chat proxies 30 for both incoming and outgoing chat messages. In one embodiment, for example, chat synchronizer 40 is configured to control the chat proxies 30 to log onto their corresponding chat platforms 50, and to automatically download the contents of the user's contact list for each chat platform 50 on which the user has an active account. Once the user's contact information has been downloaded from each of the chat platforms 50, the chat synchronizer 40 aggregates the contact information into the user's chat profile, and organizes that contact information such that the chat proxies 30 are able to subsequently utilize that information to establish, join, and maintain chat sessions with other users independent of any particular chat platform 50. Additionally, the chat synchronizer 40 is configured to synchronize all inbound and outbound chat dialogue between users in chronological order, route those messages to its proper destination, and modify the chat messages, where necessary, to identify the particular user associated with sending the chat message. Such synchronization may be based, for example, on a timestamp that is received with the chat messages indicating the date and time that the chat messages were received at the chat synchronizer. The chat synchronizer 40 also broadcasts the chat messages to each of the users involved in a chat session based on the type of chat platform 50 each user is attached to.

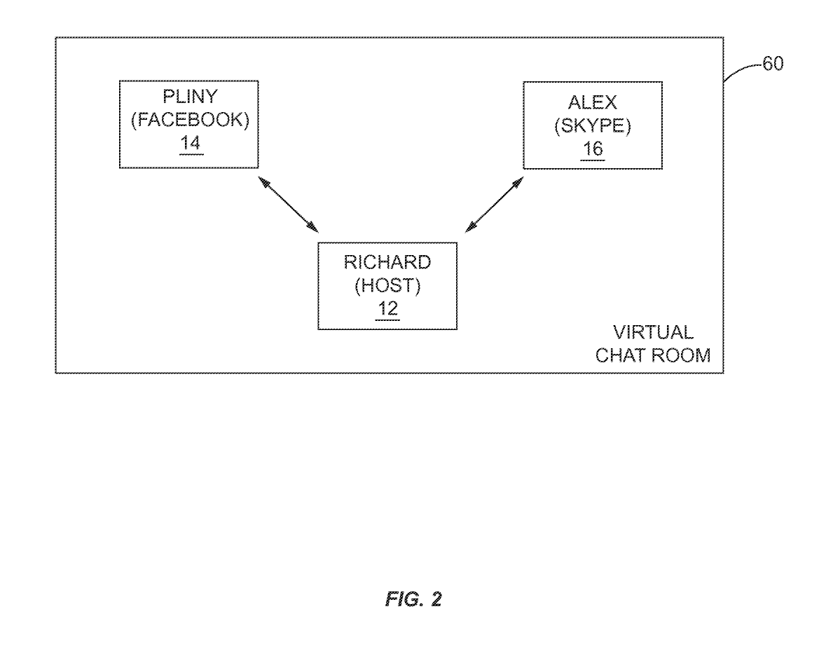

FIG. 2 is a functional block diagram that illustrates the chat synchronizer 40 facilitating such cross-platform chat sessions according to one embodiment. As seen in FIG. 2, the chat synchronizer 40 generates a “virtual chat room” 60 to host each user involved in a given chat. In one embodiment, the virtual chat rooms 60 are created and maintained centrally at chat server 20. However, in other embodiments, copies of the virtual chat rooms 60 are also maintained at each client device 12, 14 participating in the chat. In these latter situations, the virtual chat room 60 at the chat server 20 is referred to as the “master chat room,” and each of the copies of the virtual chat room 60 at the client devices are referred to as “slave chat rooms.” According to the present disclosure, the master chat room is updated with changes to the chat session (e.g., inbound/outbound messages), and then propagated to each of the slave chat rooms. Regardless, the virtual chat rooms 60 are generally created at the request of a host user, and allow each user to communicate chat dialogue with each of the other users as if they were all on the same chat platform and logged onto the same chat service, even though one or more of the users may actually be logged onto different, “communicatively incompatible” chat platforms 50.

For example, as seen in FIG. 2, Richard, who is the host user, is associated with client device 12 and is a registered user of the local chat service provided by the local chat platform on chat server 20. Pliny and Alex, each of which is associated with a respective client device 14, 16, are not registered users of the same local chat service as Richard. Rather, Pliny and Alex have respective FACEBOOK and SKYPE accounts. However, even though none of the users seen in FIG. 2 are on the same chat platform 50, the chat synchronizer 40 allows each of the users to send and receive chat messages between them as if they were all in the same chat room being hosted by the same chat platform. Further, these functions are performed by the chat server 20 without requiring any of the users to download and utilize a proprietary user application. Thus, Pliny, Alex, and Richard all communicate with each other utilizing the particular user interface provided by their respective chat platforms 50. That is, Pliny would use the FACEBOOK MESSANGER interface to communicate with both Richard and Alex, while Alex would use the SKYPE messaging interface to communicate with both Pliny and Richard. Richard, similarly, would utilize whatever chat interface was provided by the local chat service hosted by chat server 20.

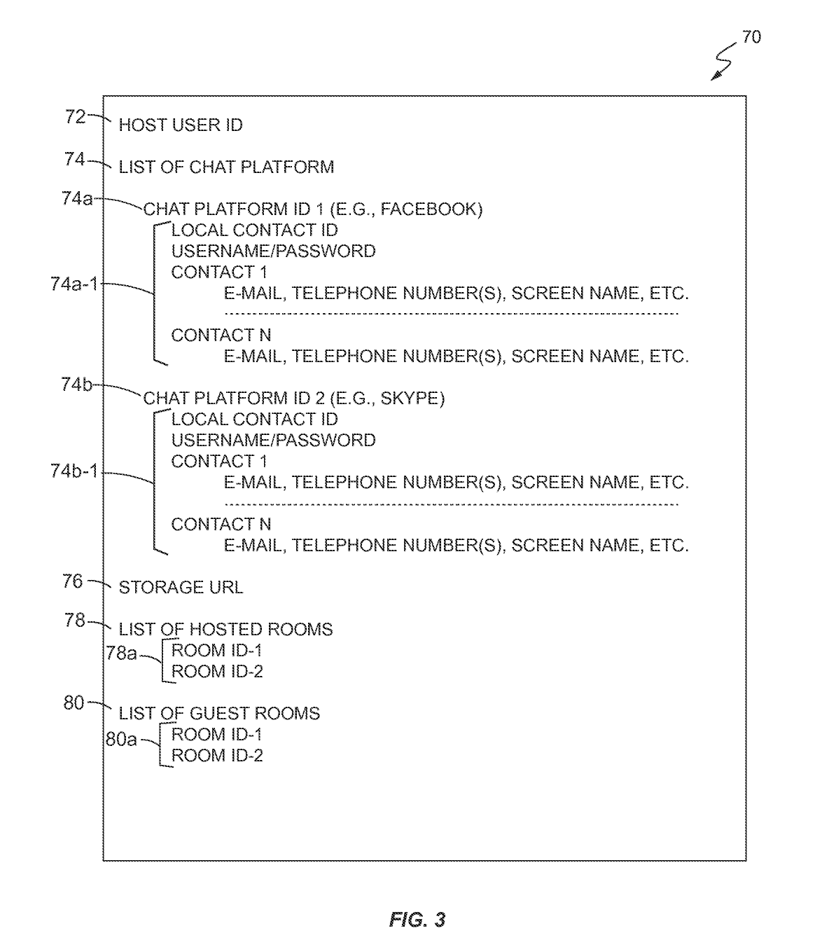

To facilitate such cross-platform chat capabilities, embodiments of the present disclosure generate and maintain a Host User Profile for each user that is a registered user of the local chat service provided by the local chat platform on the chat server 20. Users that are not registered users of the local chat service (i.e., users that are associated only with the third-party chat platforms 50, such as FACEBOOK, SKYPE, and the like), do not receive Host User Profiles. According to the present disclosure, the Host User Profile integrates a variety of data and information associated with a given user, and maintains that data and information for the chat synchronizer 40 so that the given user (e.g., Richard) can invite other users (e.g., Pliny and Alex) to a chat session. Although the Host User Profile may comprise any information known in the art, one embodiment of the present disclosure utilizes a Host User Profile 70 such as the one seen in FIG. 3.

As seen in FIG. 3, the Host User Profile 70 identifies a Host User ID 72, a List of Chat Platforms 74, a Storage URL 76, a List of Hosted Rooms 78, and a List of Guest Rooms 80. This information is utilized, as described later in more detail, to support functions such as creating a virtual chat room 60, and inviting other users into that virtual chat room 60.

### Host User ID

The Host User ID 72 identifies a given user on the local chat service provided by chat server 20. The Host User ID is unique to the user, and allows the chat synchronizer 40 to aggregate all other information related to the given user (e.g., contact lists, storage addresses, chat platforms, etc.) under a single umbrella. The Host User ID 72 may comprise any type of identifier known in the art, but in one embodiment, comprises an alpha-numeric label that uniquely identifies the user. By way of example only, a Host User ID 72 for Richard (seen in FIG. 2) may be “Richard5510.” As described later in more detail, the chat synchronizer 40 utilizes the Host User ID 72, as well as other information related to the user in Host User Profile 70, to create and maintain a “virtual chat room” 60 so that users on other chat platforms are able to engage in a chat dialogue with the user identified by the Host user ID 72.

### List of Chat Platforms

The List of Chat Platforms 74 comprises a plurality of fields that identify all of the various third-party chat platforms 50 (e.g., FACEBOOK, SKYPE, etc.) to which the user identified by the Host User ID 72 has an active account. Each chat platform ID 74a, 74b uniquely identifies a given chat platform 50, and stores data and information—74a-1 and 74b-1, respectively—that relate the user identified by the Host User ID 72 to that chat platform 50. The IDs used to identify the chat platforms 50 according to the present disclosure may be generated using any known method. However, in one embodiment, the chat platform IDs 74a, 74b are generated using a concatenation of a unique network identifier for the chat platform 50 and the Host User ID 72 of the user.

For example, the chat platform ID 74a for the FACEBOOK chat platform 52 could be “FB-Richard5510,” which is derived by concatenating a FACEBOOK network ID (e.g., “FB”) and the user's Host User ID 72 (“Richard5510”) for the Host User Profile 70. Similarly, the chat platform ID 74b for the SKYPE chat platform 54 could be “SKP-Richard5510,” which is derived by concatenating a SKYPE network ID (e.g., “SKP”) and the user's Host User ID 72 (“Richard5510”). Of course, it is possible to generate an identifier that uniquely identifies any of the chat platforms 50 using other methods as needed or desired.

As stated above, each chat platform ID 74a, 74b further comprises a set of information 74a-1, 74b-1, respectively, that relate the user identified by the Host User ID 72 to that particular chat platform 50. While the information may comprise any type of information needed or desired, one embodiment of the present disclosure tracks a local contact ID (e.g., a screenname or other identifier) that uniquely identifies the user within the realm of the particular chat platform 50, a Username and Password that is required to authenticate the user for accessing his/her account on that particular chat platform 50, and a list of contacts (i.e., Contact 1 . . . Contact N) that identifies each of the user's contacts on that particular chat platform 50. Additionally, the contact information (e.g., email address, phone number(s), screen name, etc.) for each Contact 1 . . . N is also stored.

As described in more detail later, the chat synchronizer 40 is configured to automatically download the contacts and their corresponding contact information from each of the particular chat platforms 50. This is accomplished, for example, by the chat synchronizer 40 logging onto the particular chat platform 50 using the user's Username and Password stored in the Host User Profile 70, and then interacting with a set of known APIs for that chat platform 50 to retrieve a copy of the user's contact information. The chat synchronizer 40 may perform this function automatically without user interaction, or in response to receiving a user command, or both. Regardless of how the chat synchronizer 40 obtains the contact information, however, chat synchronizer 40 is configured according to the present disclosure to analyze the retrieved information for content. Based on that analysis, the chat synchronizer 40 is configured to organize the information such that the data is stored on a “per-contact” basis with any disparities in the data (e.g., duplicate contact entries) identified and resolved. Resolution of such disparities may be performed automatically using any known technique. By way of example only, the contact information for duplicate entries of the same contact may be consolidated. Once the information is consolidated, one of the duplicate entries may be deleted. Alternatively, or additionally, the chat synchronizer 40 may simply identify suspected disparities in the contact list data and notify the user, who will then be responsible for manually correcting those disparities.

In many situations, a given user may have some of the same contacts in different chat platforms 50. For example, Richard may have Pliny as a contact in both his FACEBOOK account and his SKYPE account. The contact information for the contacts is often entered directly into the platforms 50 manually by the user, or imported from one or more other contact lists; however, it is not always updated by the user when the information changes on a timely basis. Thus, it is possible that the contact information for any given contact may be different between the various chat platforms 50. For example, the FACEBOOK platform 52 may contain an old email address for Richard's friend Pliny, while the SKYPE platform 54 contains a newer or updated email address for Richard's friend Pliny. The embodiments of the present disclosure are configured to recognize such disparities between user data (e.g., by comparing the contact information for a user as retrieved from multiple chat platforms 50), and then automatically correct the disparity by overwriting the old information obtained from one platform 50 with the updated information obtained from the other platform 50. In some embodiments, the chat synchronizer 40 is configured to simply detect the disparity in the contact information, and then send a notification to the user identifying the disparity so that the user can subsequently manually correct the data.

### Storage URL

The Storage URL 76 comprises a link or other pointer that identifies a memory location on a storage medium (e.g., a computer server, mass storage device, etc.) that stores media assets associated with the user. Such assets include, but are not limited to, text documents, images, video, audio files, and the like. Generally, the server device (or other media storage device) on which the memory location resides is partitioned into two parts—a “private” section of memory, which stores data and information that is private to the user and not shared with other user, and a “public” section of memory, which stores the data and information that the user will share with other users in a chat session, for example. According to the present disclosure, the storage URL 76 points to the public section of the memory so as to maintain security for the private section of memory. However, the Storage URL is fully customizable by the user associated with the Host User ID 72. Thus, the user is able to provide access to the private section of memory if he/she desires. Further, access to either section of memory can be governed by the user, who can specifically identify the type of access that other user are permitted to one or both sections of memory (e.g., READ-ONLY access).

According to the present disclosure, the Storage URL 76 is sent in the chat messages to the other users rather than the asset itself. That is, if the user wants to share an image with the other users in a chat session, the user could “attach” the image to the chat message, as is conventional. However, rather than send the actual attached image, the chat synchronizer 40 would send the link stored in the Storage URL 76, which may be modified slightly to also include an identifier (e.g., filename) of the image being attached. Upon receipt by another user, the chat platform 50 that hosts the user would be responsible for downloading the image pointed to by the link in the chat message, and displaying that image.

### List of Hosted Rooms

The List of Hosted Rooms 78 maintains a list of one or more Room IDs 78a, 78b, that uniquely identify each of the virtual chat rooms 60 that are being hosted by the user. The chat synchronizer 40 is configured to generate a virtual chat room each time a user requests a chat session. Thus, a single user may have multiple virtual chat rooms 60 that he is hosting. Each Room ID is automatically generated by the chat synchronizer 40 upon receiving a request by a user identified by a Host User ID 72 to establish a chat session with one or more other users. Like the chat platform IDs 74, the Room IDs 78a, 78b may be derived by concatenating an arbitrary “Room Identifier” (e.g., “ROOM 1”) with the Host User ID 72 (e.g., “Richard5510”). Alternatively, however, the Room IDs 78a, 78b may be derived using randomly generated information as is known in the art.

### List of Guest Rooms

Just as the chat synchronizer 40 tracks each of the virtual chat rooms 60 that are created by (i.e., hosted by) the user, chat synchronizer 40 also creates and maintains a List of Guest Rooms 80 comprising Room IDs 80a, 80b that uniquely identify each virtual chat room 60 in which the user is a guest. Such rooms are created, as described above, by another user (i.e., the host), and thus, the Room IDs 80a, 80b in the List of Guest Rooms 80 reflect the Room IDs generated for that host.

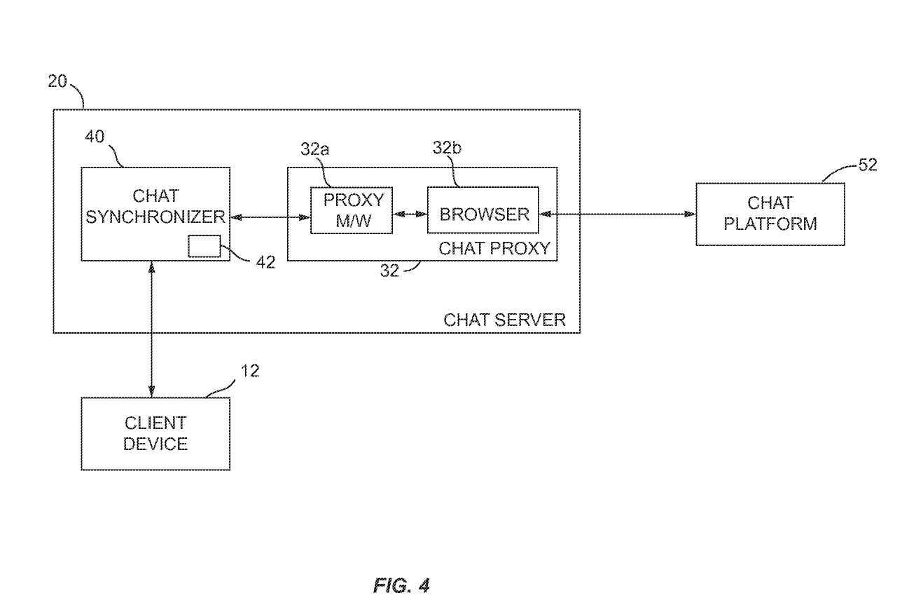

FIG. 4 is a functional block diagram illustrating the chat proxy 30 functionality and interaction with the chat synchronizer 40 and the chat platforms 50 in more detail. As seen in FIG. 4, the functionality and the interoperability of the chat proxies 30 are described in the context of an interaction with the FACEBOOK platform 52. Thus, the particular chat proxy 30 used in this example is the FACEBOOK proxy 32. Of course, there may be differences in their implementation, as each chat proxy 30 is unique to a particular chat platform 50. However, those of ordinary skill in the art will realize that the following description is merely illustrative, and that the concepts described with respect to chat proxy 32 may be applied to any chat proxy 30.

As seen in FIG. 4, the FACEBOOK proxy 32 is executed on the chat server 20, and is disposed between the chat synchronizer 40 and the FACEBOOK platform 52. Additionally, the FACEBOOK proxy 32 comprises a proxy middleware component 32a and a browser application 32b. The browser application 32b has established a communications session with the FACEBOOK platform 52 using, for example, the user's Username and Password stored in the user's Host User Profile 70.

In operation, the client device 12 provides user commands and chat message content to the chat synchronizer 40. Upon receipt, the chat synchronizer 40 determines the appropriate chat proxy 30 to invoke, updates its routing table accordingly, and then sends the user commands and other content received from client device 12 to the selected chat proxy 30, which in the embodiment of FIG. 4 is the FACEBOOK proxy 32. The proxy middleware 32a receives the commands and content from the chat synchronizer 40 as input, and provides that information as keystrokes to the browser application 32b. The browser application 32b, in turn, sends the appropriate commands and content to the FACEBOOK platform 52 in a format that is compatible with the FACEBOOK platform 52. Thus, the proxy middleware 32a appears to the browser application 32b as if it were an actual user inputting keystrokes at a keyboard.

For data and information originating from the FACEBOOK platform 52 (e.g., a chat message sent by a user having a FACEBOOK account), the browser application 32b receives the information and passes that information to the proxy middleware 32a. The proxy middleware 32a then provides that received content as text, for example, to the chat synchronizer 40. Upon receipt, the chat synchronizer 40 determines which client device 12, 14 should receive the content based on the routing table 42, and sends that content to the selected client device 12. In some instances, the chat synchronizer 40 may need to translate the commands and content received from the proxy middleware 32a into a format that is compatible with the user's chat application executing on client device 12.

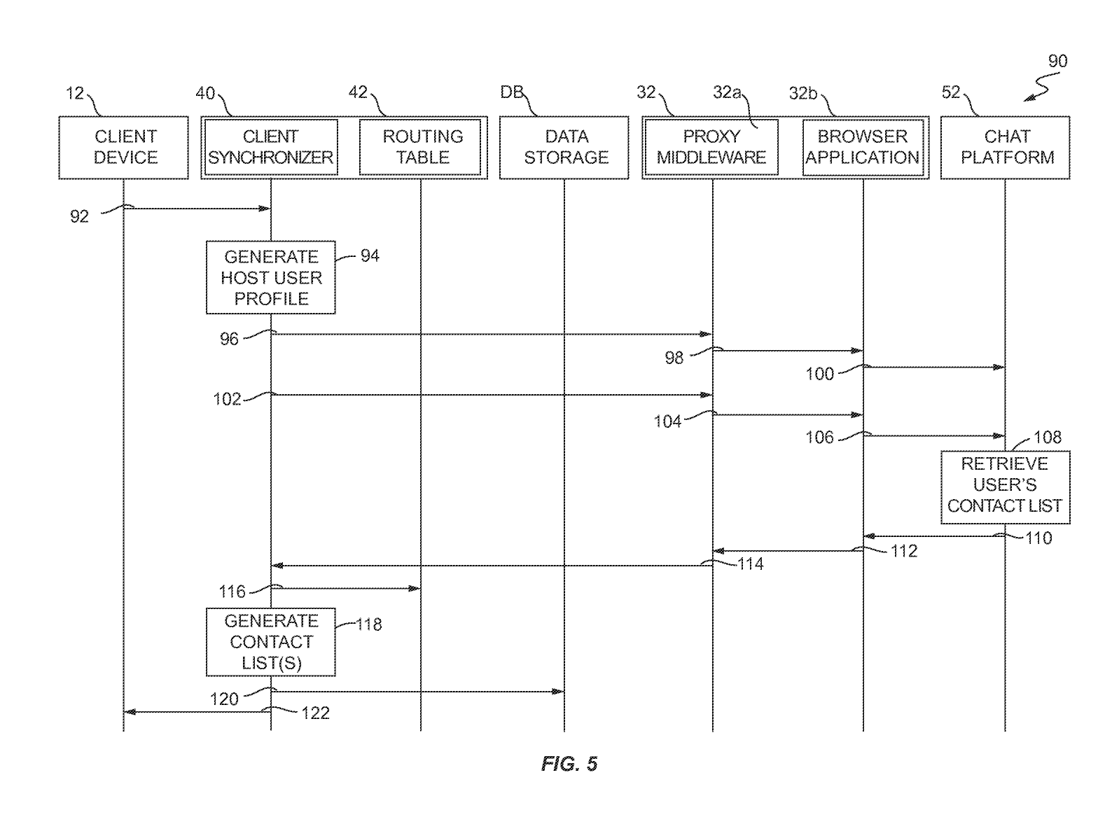

FIG. 5 is a signaling diagram illustrating a method for registering a user with the local chat platform of chat server 20, and for obtaining the user's contact lists from another chat platform 50 according to one embodiment of the present disclosure. The interaction seen in FIG. 5 illustrates generally the messaging that is exchanged between components when a user first registers with a chat service provided by the chat server 20. This particular chat service, which is referred to herein as being provided by a “local” or “internal” chat platform, is hosted by the chat server 20, and thus, independent of from the chat platforms 50 previously described.

As seen in FIG. 5, method 90 begins when a user (e.g., the user of client device 12) sends a request to the chat server 20 to register with the local chat service (line 92). The request, which is generated by a user application associated with the local chat platform on chat server 20, may include any data known in the art. However, in one embodiment, the request message comprises the user's name, identifies the various chat platforms 50 on which the user has an open, active account, and a username/password combination for each identified chat platform 50. Upon receiving the registration request message, the chat synchronizer 40 utilizes the information received in the request to generate a Host User Profile 70 for the user (box 94), and then proceeds to log onto a first of the identified chat platforms 50 as the user. For example, in the embodiment of FIG. 5, the chat synchronizer 40 logs into the user's FACEBOOK account.

More specifically, the chat synchronizer 40 first identifies the appropriate chat proxy for FACEBOOK (i.e., FACEBOOK proxy 32), and then sends that proxy a command to log onto the user's FACEBOOK account (line 96). The command may include, for example, the user's Username/Password combination previously received in the registration request message. As previously described, the proxy middleware 32a receives the command, and forwards that command (along with the parameters) as text to the browser application 32b (line 98). If the browser application 32b is not already executing, then the proxy middleware may autonomously issue a command to start executing the browser application 32b on chat server 20. Regardless, the browser application 32b will then execute the appropriate logon commands to log onto the user's FACEBOOK account as the user (line 100).

In some cases, although not required, the chat platform 52 may return a success or fail indication (not shown) to the browser application 32b to indicate whether the logon was successful. In some embodiments, this indication may be passed back to the chat synchronizer 40 and/or to client device 12, so that appropriate remedial steps may be taken.

Assuming that the logon was a success, however, the chat synchronizer 40 will then automatically generate a request for FACEBOOK platform 52 to obtain the user's contact list (line 102). As before, the request first passes through the proxy middleware 32a, and then is passed to the browser application 32b as text (line 104). Upon receipt, the browser application 32b will generate and send a request to FACEBOOK platform 52 to export the user's contact list (line 106). The request may be accomplished, for example, utilizing a function provided by an application programming interface (API) that is exposed to browser application 32b by FACEBOOK platform 52.

Upon receipt of the request, FACEBOOK platform 52 retrieves the user's contact list information (box 108), and returns that information to the chat synchronizer 40 (lines 110, 112, 114). The chat synchronizer 40 then updates the routing table 42 with the user's information (e.g., the user's Host Profile ID 72) (line 116), generates the Contact List ID 74 for FACEBOOK in the user's Host User Profile 70 (box 118), and archives the registration request and the corresponding data in a storage medium, such as DB (line 120). In some embodiments, the chat synchronizer 40 will also send an acknowledgment to the client device 12 to inform the user of the status of the registration (line 122).

As stated above, method 90 seen in FIG. 5 is described with respect to a single chat platform 50. However, method 90 may be applied to each chat platform 50 on which the user has an active account. Further, as previously described, the chat synchronizer 40 is configured to analyze the contact list information exported by each of the chat platforms 50 in order to detect any data anomalies. Such an analysis may occur at any time, but in one embodiment, is performed by the chat synchronizer 40 upon receipt of the contact list information and prior to (or concurrently with) generating the Contact List IDs 74 (i.e., box 118). If anomalies are found, chat synchronizer 40 may be configured to attempt to try and correct the errors autonomously, and/or to generate a notification message to the client device 12 to alert the user. So informed, the user of client device 12 can then manually correct the anomalies.

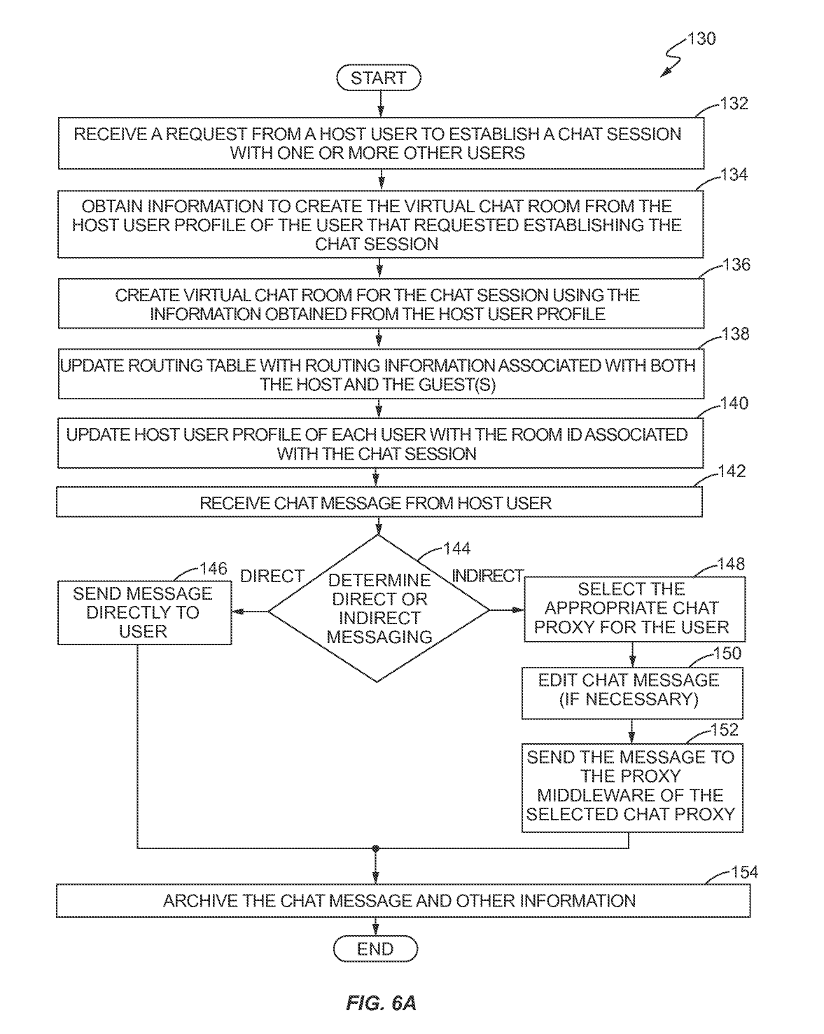

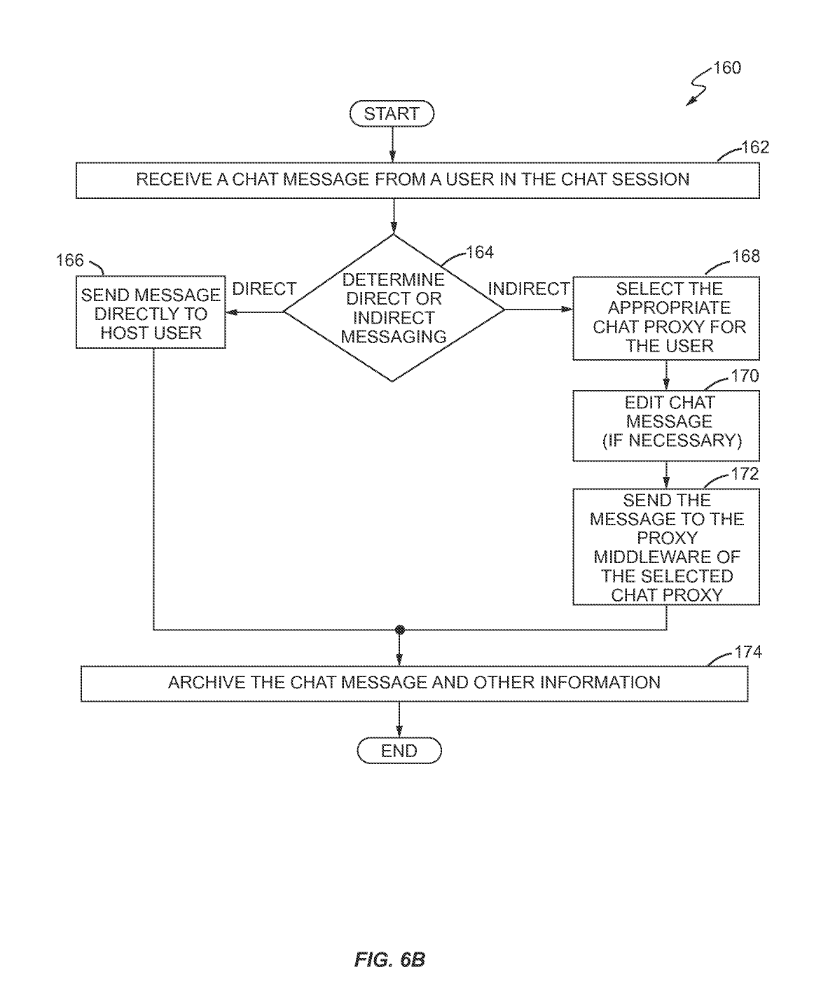

FIG. 6A is a flow diagram illustrating a method 130, performed by chat synchronizer 40, for routing chat messages between users of the same, and different, chat platforms. As seen in FIG. 6A, the chat synchronizer first receives a request to establish a chat session with one or more users from a user of the local chat platform (i.e., the chat service provided by chat server 20) (box 132). The request may comprise, for example, an explicit request to establish a chat session with one or more other selected users, or a chat message generated by the user of client device 12 and sent to the one or more selected users. Regardless, the chat synchronizer 40, upon receipt of the request, obtains the information to create a virtual chat room 60 from the Host User Profile 70 associated with the user of client device 12 (box 134). For example, in one embodiment, the chat synchronizer 40 will retrieve the Host User Profile 70 from the DB. Chat synchronizer 40 then creates the virtual chat room 60, and uniquely identifies that chat room by concatenating, for example, the Host User ID 72 of the user with a random number (box 136). Of course, other methods for uniquely identifying the generated virtual chat room are also possible, as is known in the art.

Chat synchronizer 40 then updates the routing table 42 with the information associated with the creation of the virtual chat room 60 (box 138). For example, the routing table 42 may comprise a table stored in a local memory circuit of chat server 20, or in some other media storage device, such as DB. In any case, chat synchronizer 40 could associate the routing table 42 with the unique Room ID for the virtual chat room 60 that was created, and then create entries for insertion into the routing table 42 associating the Host User ID 72 of the user that caused the chat room to be generated with a name of the chat proxy that was selected for the user, if any. In addition, the chat synchronizer 40 could also associate the Contact IDs and chat proxies 30 of each of the other users that are in the virtual chat room 60 and participating in the chat session. Such information may be obtained, as previously described, from the information stored in the Contact Lists 74 of the user's Host User Profile 70. The following table illustrates the routing table 42 according to one embodiment.

TABLE 1
Example Routing Table for “ROOM 1 - Richard5510”

| USER ID | CHAT PROXY |
|---|---|
| Richard | LOCAL |
| Pliny | FB_PROXY |
| Alex | SKP_PROXY |

In addition to updating the routing table 42, the chat synchronizer 40 will also update the List of Hosted Rooms 78 stored in the user's Host User Profile 70, as well as the list of Guest Rooms 80 in the Host User Profile 70 of each of the other users (provided they are registered users of the local chat service) (box 140). Thereafter, with the virtual chat room 60 having been generated, the chat synchronizer 40 will start routing received chat messages (box 142) to the users in the virtual chat room 60.

According to the present disclosure, the chat synchronizer 40 can deliver chat messages to the users in one of two ways—direct chat messaging or indirect chat messaging. Each, however, depends on whether the user that is sending the message is currently on the same chat platform as another user that will receive the chat message.

With direct messaging, the intended recipient(s) of the chat message is on the same chat platform 50 as the user who is sending the chat message. In these cases, the chat synchronizer 40 will simply send the chat message to the intended recipient(s) using the chat delivery services of that particular chat platform 50. Thus, there is no need for the chat synchronizer 40 to translate message content or formats, for example, in these types of messages. Indirect messaging, however, involves a situation where one or more of the intended recipient(s) of the chat message and the sending user is/are on different, possibly incompatible, chat platforms 50. In these cases, chat synchronizer may be configured to translate the chat messages between the formats of the chat platforms, if needed. The information needed to perform such translations may be provided, for example, to the chat server 20 as part of a provisioning process.

Regardless, the chat synchronizer 40 determines whether direct or indirect messaging is required to communicate the received chat message to the other users in the virtual chat room 60 (box 144). This determination may be made, for example, by comparing a unique name assigned to the chat proxy 30 of the user that sent the chat message to the respective chat proxies 30 of each intended recipient. Provided the chat proxies 30 are the same, chat synchronizer 40 sends the chat message to the intended recipient(s) via direct messaging (box 146). Otherwise, the chat synchronizer 40 sends the chat message to the intended recipient(s) via the identified chat proxy 30.

Particularly, using the routing table 42, the chat synchronizer 40 will locate the intended recipient(s) and determine the chat proxy 30 with which they are associated (box 148). Chat synchronizer 40 will then edit the chat message content, if necessary, to ensure that the receiving user(s) know who sent the chat message (box 150). For example, the chat synchronizer 40 may add the sending user's name and/or other contact information to the content of the chat message (e.g., “From Richard”). This aspect allows each of the users to employ their own platform-specific user application to create and receive chat messages, without sacrificing the ability to identify the author/sender of the chat message. The chat synchronizer 40 then sends the edited chat message, along with the user's Local Contact ID, Username, and Password for that chat platform 50, to the proxy middleware of the selected chat proxy 30 to send on to the associated chat platform 50 (box 150). This allows the proxy middleware to control the browser application to log onto the chat platform 50 as the user, and to send the chat message to the intended recipient(s) as if the user were actually logged onto the chat platform 50. In some embodiments, the chat synchronizer 40 will also log the contents of the communicated chat message to a storage medium, such as DB (box 154).

While FIG. 6A illustrates a method 130 for generating a virtual chat room 60 and communicating chat messages to the users in that room as a host user, FIG. 6B illustrates a method 160 in which the user is a guest user in the virtual chat room 60. More specifically, method 160 begins with the chat synchronizer 40 receiving a chat message from a user in the virtual chat room 60 (box 162). As above, chat synchronizer 40 will then determine whether the chat message is to be sent to the other user(s) as a direct message or an indirect message (box 164). Direct messages simply utilize the chat delivery services that are common between the users (box 166) to deliver the chat messages. Indirect messaging, however, controls the chat synchronizer 40 to select the chat proxy 30 that is appropriate for the intended recipient(s) of the chat message (box 168), edit the message to identify the sender, if needed (box 170), and send the message to the proxy middleware function of the selected chat proxy 30 (box 172). As above, the chat synchronizer 40 sends the user's Local Contact ID, Username, and Password for the chat platform 50 to the proxy middleware function of the selected chat proxy 30 to allow the proxy middleware to control the browser application to log onto the chat platform 50 as the sending user, and to send the chat message to the intended recipient(s) as if the user were actually logged onto the chat platform 50. Additionally, chat synchronizer 40 may be configured to archive the chat messages in a storage media, such as DB, for example.

As stated above, chat synchronizer 40 will determine whether to send a given chat message using direct or indirect messaging. Additionally, however, chat synchronizer 40 is also configured to send or hold a given chat message based on whether an intended recipient user is on-line. Particularly, if a routing table 42 comprises an entry for a user, chat synchronizer 40 can assume that the user is on-line. In these cases, chat synchronizer 40 can send the chat message utilizing direct/indirect messaging, as previously described. If the user is not on-line, however, the chat synchronizer 40 will send the message in one of two ways. Particularly, if the intended recipient user is a registered user of the local chat platform provided by chat server 20, chat synchronizer 40 will queue the chat message until the user logs on to the local chat service. However, if the user is attached to an external chat platform 50 (e.g., FACEBOOK or SKYPE), chat synchronizer 40 will send the chat message to the chat proxy 30 associated with that particular chat platform 50. Upon receipt, the chat platform 50 will deliver the chat message to the user so that the user will receive the chat message upon logging onto the service.

As previously stated, the chat proxies 30 are associated with a particular chat platform 50, and may be utilized by chat synchronizer 40 to log onto the user account as the user. This can be accomplished, according to one embodiment, by providing the Username and Password stored in the user's Host User Profile 70 as input to the proxy middleware of the corresponding chat proxies 30. The proxy middleware, in turn, controls its corresponding browser application to generate the commands necessary for the browser application to access the user's account as if the user were actually providing the Username and Password at a keyboard communicatively connected to the browser application.

However, those of ordinary skill in the art should readily appreciate that the embodiments of the present disclosure are not so limited. In another embodiment, the present disclosure utilizes one or more of the chat proxies 30 as if they were actual users on the corresponding chat platform 50. That is, according to at least one embodiment of the present disclosure, a chat proxy (e.g., FACEBOOK proxy 32) is set up with a user account (i.e., a “proxy user ID account) on a chat platform (e.g., FACEBOOK 52) as if the FACEBOOK proxy 32 were an actual user. Thereafter, rather than log onto FACEBOOK using the user's credentials, the FACEBOOK proxy 32 will log onto FACEBOOK as itself and send the chat messages to other FACEBOOK recipients involved in the chat session. In these cases, however, the present disclosure configured the chat synchronizer 40, as stated above, to identify both the user that actually sent the message, as well as the particular chat proxy 30 that was used to send the message.

### Setting Up Proxy User ID Accounts

The proxy user ID accounts are registered on the chat platforms 50, and are created and activated for the chat proxies 30 to operate as active, independent end-users on chat platforms 50. The proxy user ID accounts are created, maintained, and referenced by a separate database management system hosted on chat server 20 (e.g., chat synchronizer 40). This system is configured to create the proxy user IDs that are used to uniquely identify these types of chat proxies 30, and to allow the processes for communicating chat messages that utilize the routing table 42 to operate as previously described.

There are three types of proxy user ID accounts that may be created to host the corresponding proxy user IDs. These are Direct Accounts, Indirect Accounts, and third party satellite accounts.

### Direct Accounts

There are two types of direct accounts—non-business-type direct accounts and business-type direct accounts. Non-business type direct accounts are set-up for each of the proxy user IDs, and provide the necessary inbound and outbound messaging services needed to successfully fulfill its functions. This type of account is created directly with the chat platforms 50 using an email address and/or mobile number that is associated with the chat proxy 30. Once created, the account is assigned a Proxy Name and a Proxy Avatar.

The Proxy Names assigned to the accounts may be any name or label desired. The Proxy Name may be descriptive of an organization, for example, or may be more specific as to the particular function or use of a given chat proxy 40. Additionally, the Proxy Name may be a whimsical name or label, or be labeled in a manner that makes organizational sense. Thus, Proxy Names in accordance with the present disclosure may fall under virtually any category.

The following table lists some examples of Proxy Names, which are also referred to as virtual account identities.

TABLE 2

| CATEGORY | EXAMPLE PROXY NAME |
|---|---|
| MobileTelephone Numbers | +1-917-555-5555 |
| Random Names | John Doe 1, Message 4U . . . |
| Mythological Figures | Hermes |
| Non-Profit Organisations/NGO's | Red Cross, Unesco |
| Famous Places | Paris, France, Nile River, Mount |
| | Everest |
| Former Presidents | Washington, Lincoln |
| States in America | New Jersey, North Carolina, New York |
| Rivers of the world | Mississippi, Columbia, Danube |
| Commercial AD Brands | Coke, Pepsi |
| Live Celebrity Branding | Beyonce |
| Non-Profit Brands | Red Cross |
| Famous Names/Concepts | Nikola Tesla |
| Business/Corporate Ad Brands | IBM, MICROSOFT |
| Anonymous/Random Names | Jon Doe, Jane Doe |
| User Volunteer Postman | Kevin Koplin |
| Routing System | Message Translation |

Of course, the information in Table 2 is merely illustrative, and those of ordinary skill in the art will appreciate that any name or label may be utilized with the embodiments of the present disclosure. Regardless of the particular name, however, that information will appear in the header part of every chat message exchanged by the chat proxy 30. The mobile number, if used, may be provided by a SIM card that is acquired for activation of the account. Further, this information can appear as needed or desired as the screen name in the header part of the chat messages.

### Non-Business Type Direct Accounts

The following are some examples of non-business type direct accounts that may be created and activated, as well as some of their corresponding parameters used in creating and activating the accounts, according to embodiment of the present disclosure.
GOOGLE GMAIL Accounts: This account may use a first name, last name, email address, and mobile number.
Email Account: This is one or more email addresses associated with a chat proxy (ex: SuperMan@gmail.com). Each email address would have its own, unique email address.
MICROSOFT Accounts (e.g., HOTMAIL & OUTLOOK), AOL Accounts, and YAHOO Accounts: These accounts are similar to the Email Account example above, and thus, utilize similar information.
WHATSAPP Accounts: These accounts may be created and activated with an associated mobile telephone number (e.g., 917-555 5555), and/or some other mobile number retrieved from a SIM card, for example.

### Business-Type Direct Accounts

Business-Type Direct Accounts provide a higher level of protection for the proxy user IDs than do the non-business-type direct accounts. Thus, business-type direct accounts operate as a controlled safe-havens for the aliases associated with the chat proxies 30 such that the associated proxy user IDs are virtually untraceable. However, the limitation of such Business-type Direct Accounts is that they only provide inbound messaging and translation services to the chat proxies 30. Business-Type Direct Accounts are not configured to provide such messaging and translation services for return messages. Therefore, a particular proxy user ID alias for each chat proxy associated with a business-type direct account will be paired in the management system with a counterpart Non-Business-Type Direct Account proxy user ID. Pairing these accounts will provide the necessary outbound or return messaging required for completing the translation process.

The following example illustrates the information required for the creation and activation of a Business-Type Direct Account (i.e., a Google Business User Account).
Company name (e.g., ABC, Inc.);
a First and Last name (ex. Richard Smith);
an email (ex. richardsmith@gmail.com);
a mobile number (ex. 917-555 5555);
a Payment method (ex. PAYPAL or VISA).

Additionally, Business-Type Direct accounts allow for the creation of multiple proxy user IDs as aliases hosted under the business account by creating a particular domain name (ex: FreeYourWorld@ABCompany.com). Under this domain hosting URL, multiple aliases for the chat proxies are deployed—each with their own unique alias and/or avatar. Some examples of such aliases are:
Proxy Alias 1 (ex: Red Cross/RedCross@NGO.org)—Inbound messaging only.
Proxy Alias 2 (ex: Coca Cola/Coke@ADPost.com)—Inbound messaging only.
Proxy Alias 3 (ex: Message 4U/Message4U@Chat.im)—Inbound messaging only.
   There is no restriction on the number of aliases that can be created for each chat proxy, and each can be assigned virtual screen names and avatars.

As previously stated, because Business-Type Direct Accounts provide inbound messaging only, the proxy user IDs associated with these accounts are automatically paired in the management system with corresponding Non-Business-Type Direct Account proxy user IDs to facilitate outbound messaging, when such messaging is needed.

### Indirect Accounts:

According to one embodiment, Indirect Accounts are automatically created when Direct Account parameters are used to sign-in to a chat platform 50. For example, consider a Direct Account proxy user ID that is normally used by a chat proxy 30 to sign onto a GOOGLE account. The Direct Account proxy user ID in that case may use parameters (Proxy123/Proxy123@gmail.com/917-555-5555) in the sign-on process. If this same GOOGLE-associated Direct Account proxy user ID having those same parameters is then also used to sign into a FACEBOOK account, chat synchronizer 40 will automatically create an Indirect Account. Thus, the unique chat proxy originally considered to be an active GOOGLE user is now also considered to be a unique FACEBOOK user.

This same crisscrossing methodology—i.e., automatically creating an Indirect Account for a first chat network whenever a Direct Account for a different chat network is used to sign onto the first chat network—will be applied so as to decentralize the origin of the proxy user ID when the chat proxy 30 accesses the chat platform 50. Therefore, Indirect Accounts deliberately mix-and-match sign-up protocols to mask the proxy user ID origin and activity on these chat platforms 50.

Those of ordinary skill in the art will readily appreciate that the above examples are merely illustrative, and that Indirect Accounts may also be created for other chat platforms 50 as well. Such platforms include, but are not limited to GOOGLE-to-FACEBOOK, HOTMAIL-to-FACEBOOK, MICROSOFT OUTLOOK-to-FACEBOOK, AOL-to-FACEBOOK, YAHOO-to-FACEBOOK, GOOGLE-to-TWITTER, YAHOO-to-LINKEDIN, and the like.

### Third Party Satellite Accounts

Third Party Satellite Accounts are accounts that apply to any third party chat platform that does not have its own integrated chat messaging function (e.g., it does not have a built-in Instant Messaging (IM) function). The proxy user ID's, which are setup as active users on the chat platforms 50, are ID handles. According to embodiments of the present disclosure, the ID handles are used to communicate and translate the chat messages between a registered user of the local chat service provided by chat server 20 and a given chat platform 50 whenever that registered user does not have an active account on the given chat platform 50, but still needs to establish an inbound/outbound message connection across the given chat platforms 50. These will be accounts created via a process that allows a user to “Sign-up-Thru-FACEBOOK” or “Signup-Thru-GOOGLE” or “Sign-up-Thru-TWITTER,” for example.

As previously stated, embodiments of the present disclosure are configured to send different types of messages between users. These include, but are not limited to IM/Chat messages and Voice Call Messages.

### IM/Chat Messages

IM/Chat messages are generally text-based messages, but in some cases, these messages may also be utilized to communicate non-text components such as images (e.g., jpg files, gif files, etc.), video (e.g., mp3 files), and audio components (e.g., avi files). To create and send these types of messages, a user would first select the intended recipient(s) contact IDs contact lists from the user's Host User Profile 70. Then, the user would select a communication channel (i.e., the particular chat platform 50 associated with the intended recipient(s)) over which to send the message, as each different contact may be associated with multiple communication channels. The user then composes and sends the message to the intended user. For these types of messages, each message may comprise, for example:
a header that specifies the sender, the recipient(s) (i.e., from-to-(to-cc-bcc)), and the subject of the message; and
a message body comprising, for example, text, images, and/or video, including, but not limited to mp3, avi, jpg, and gifs.
   As described previously, one embodiment of the present disclosure sends the link identified by the user's Storage URL 76 in the message rather than the actual asset. However, those of ordinary skill in the art will readily appreciate that sending the actual asset as part of the message is also possible.

### The Voice Call/Video Call Type Message

Voice calls and video calls (e.g., FACETIME calls, teleconference calls, etc.) are also possible with to the system of the present disclosure; however, these types of calls have a different format than the previously described IM messages. To place a voice or video call, a user would select a chat contact from the contacts list stored in the user's Host User Profile 70, as previously described. The user would also indicate whether the call to the selected contact was a voice or video type call. The user would then compose the message.

The message may have any format needed or desired. However, in one embodiment, the format of each voice or video message comprises the following parameters.
A header that identifies the sender and the intended recipient (i.e., “FROM/TO);
An indicator to indicate the type of call as being a Voice call or a Video call; and
A chat channel over which to send the message.

There are three types of chat channels. These are:
An Intra-system Channel: This type of communications channel facilitates chat communications between two or more users where each user is registered as an active user on the local chat services hosted by chat server 20 (i.e., registered users of the local chat platform). Messages sent over an Intra-system Channel are sent using direct messaging.
An Inter-system Channel: In this case, one of the users (e.g., the sender) is a registered active user of the local chat platform, while the other user (e.g., the intended recipient) is not. Rather, the intended recipient has accounts only on other external third-party chat platforms 50 (e.g., FACEBOOK, GOOGLE, LINKED IN, etc.). Such users would therefore only have the third party chat network parameters (e.g., Mobile number/SMS, Email, third party handle ID) with which to communicate a message.
   This type of contact is referred to as a “potential chat contact.” With these types of contacts, a user that is registered with the local chat platform can log into the same chat platform 50 that the intended recipient is using, or activate/initiate his/her existing account on the chat platform 50 (e.g., FACEBOOK or mobile number/SMS), to reach the intended recipient. This connects the two users through the external chat platform 50 to which they already belong. This process may occur, for example, within the realm of a user application executing on client device 12 and/or 14, and may use a corresponding client interface. However, the process still uses the sign-in procedures and integrated chat functionality provided by the chat platform 50. Thus, given an example where the third party chat platform 50 is FACEBOOK, communications between the two users would be FACEBOOK Messenger to FACEBOOK Messenger. This is also a direct chat.
A Proxy-Assisted Inter-system Channel: In these cases, one of the users (e.g., the sender) is a registered active user of the local chat platform provided by chat server 20, while the other user (e.g., the intended recipient) is not. However, unlike the Inter-system Channel example above, neither user has an account on any of the same external chat platforms 50. Therefore, chat synchronizer 40 is configured to create a channel that both users can utilize to effect chat communications between them. To accomplish this, the so-called sending user selects, from his contact list in the Host User Profile 70, the other user's chat channel parameters (e.g., mobile number/SMS, Email, Facebook Messenger, and the like). The sending user then generates a chat message for delivery to the particular chat proxy 30 that is associated with the chat platform 50 of the intended recipient, and delivers the chat message to the intended recipient via that chat proxy 30, as previously described.

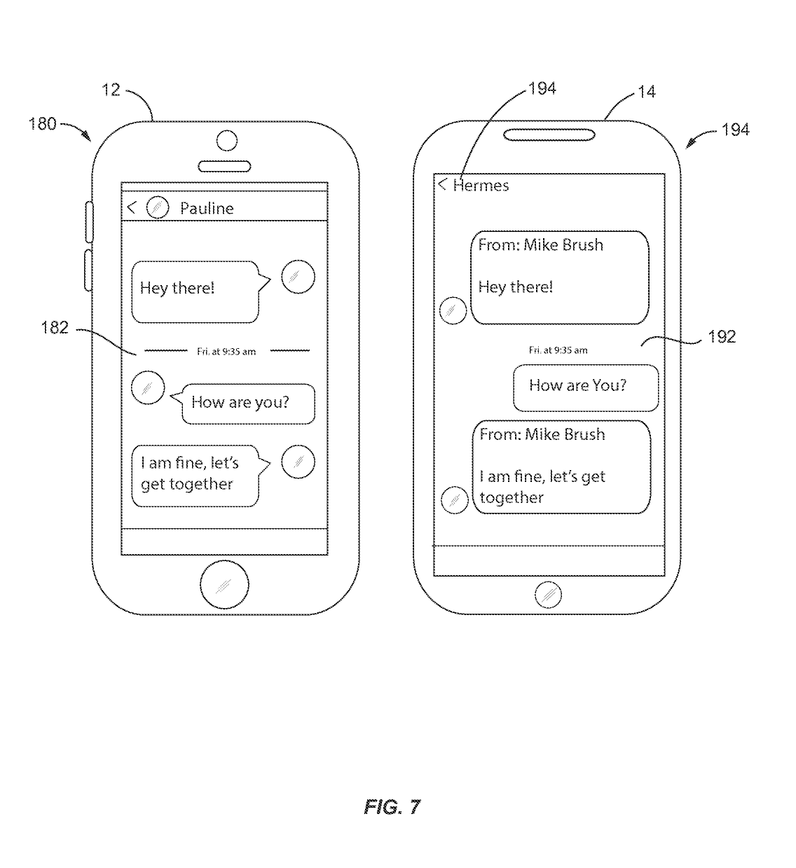

FIG. 7 is a perspective view showing client devices 12, 14 as a pair of smartphones. Client device 12 is associated with a first user “Mike” who is a registered user of the local chat platform provided by chat server 20, but not of FACEBOOK. Therefore, the user interface 182 seen on the display 180 of client device 12 is an application associated with the local chat platform provided by chat server 20. Client device 14 is associated with a second user “Pauline,” who is not a registered user of the local chat platform provided by chat server 20, but rather, has an active FACEBOOK account. The user interface 192 seen on the display 190 of client device 14 is that of FACEBOOK MESSENGER.

In this embodiment, the sender of the messages that are displayed to Pauline is identified by the sender “HERMES” 194. However, HERMES is not the actual composer of the message. Rather, HERMES is the unique name of the particular chat proxy 30 that sent the chat message on Mike's behalf. As stated previously, this is because the chat proxy HERMES, which is specifically associated with FACEBOOK, is logged onto FACEBOOK as an actual valid user. To enable Pauline to determine who actually authored and sent the message, the chat synchronizer 40 added the phrase “From Mike” to the body of the chat message prior to sending the message to the chat proxy “HERMES.”

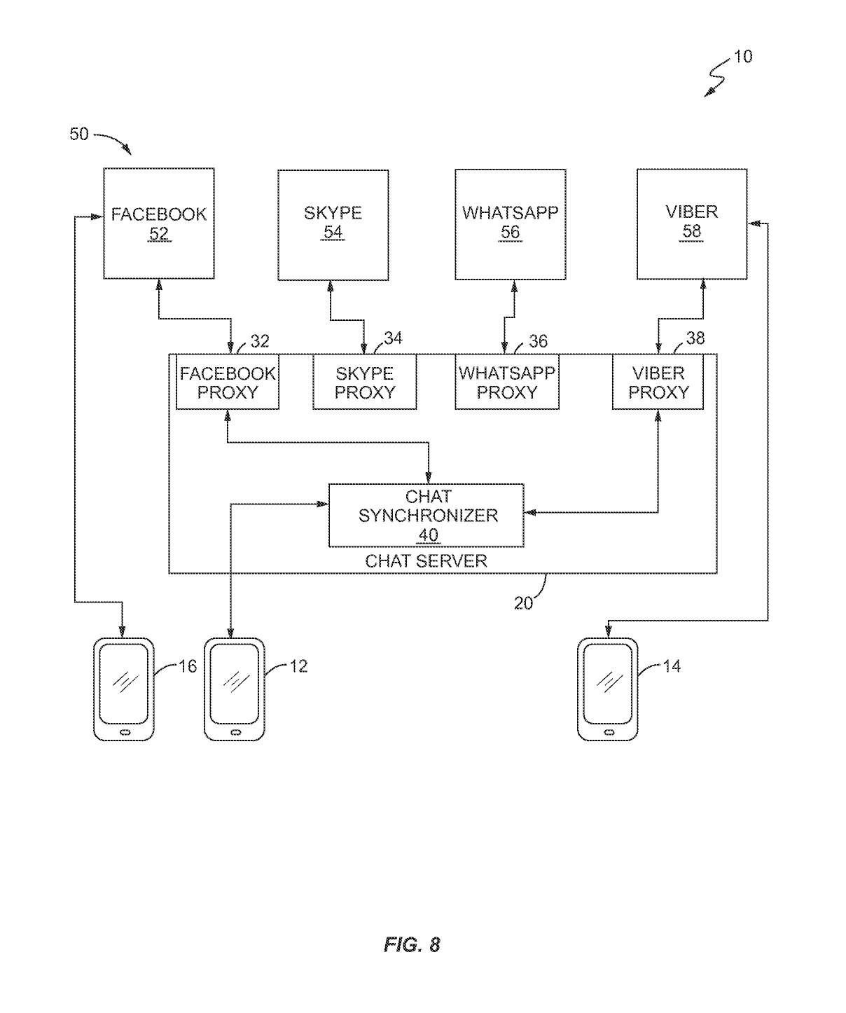

FIG. 8 is a functional block diagram illustrating system 10 with three different users—each user being associated with a different client device 12, 14, 16. Particularly, the user of client device 12 is a registered user of the local chat platform provided by chat server 20, while the users of client devices 14, 16 are not. Instead, the user of client device 14 has an active VIBER account, while the user of client device 16 has an active FACEBOOK account.

FIG. 8 illustrates system 10 configured to provide the service of the present disclosure to the three client devices 12, 14, 16 in accordance with one or more embodiments. As above, the user of client device 12 is registered with, and is an active user of the local chat platform provided by chat server 20. The user of client device 14 is logged into the VIBER platform 58, and the user of client device 16 is logged into the FACEBOOK platform 52. The chat proxies 32, 38 that are associated with the FACEBOOK and VIBER platforms 52, 58, respectively, transfer the chat messages received from client device 12 to the client devices 14, 16 via the chat synchronizer 40 in chat server 20, as previously described. The chat synchronizer 40 also synchronizes the chat messages it communicates between the client devices 12, 14, 16 in chronological order.

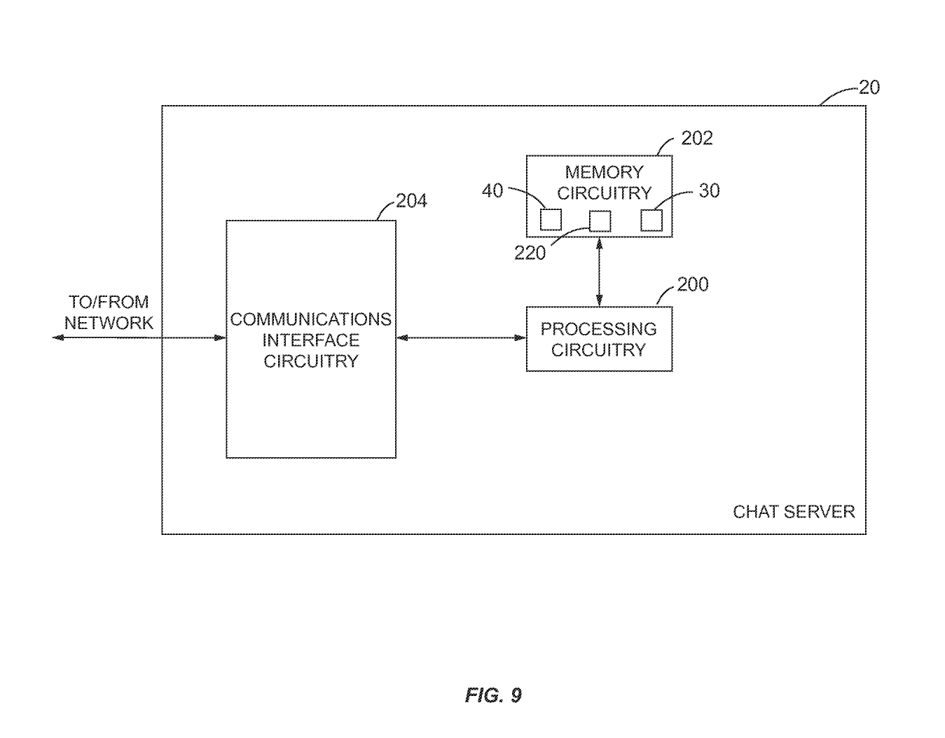

FIG. 9 is a functional block diagram illustrating some of the functional components of a physical chat server 20 (e.g., a computer server) according to one embodiment of the present disclosure. Those of ordinary skill in the art will readily appreciate that the components seen in FIG. 9 are illustrative only, and that other components not specifically shown in FIG. 9 may be present on chat server 20 as needed or desired.

As seen in FIG. 9, chat server 20 comprises processing circuitry 200, memory circuitry 202, and communications interface circuitry 204. Processing circuit 200, which may comprise one or more microprocessors, microcontrollers, hardware circuits, or a combination thereof, generally controls control the operation of the chat server 20. As seen in FIG. 9, processing circuit 200 communicatively interconnects the memory circuitry 202 and the communications interface circuitry 204. Configured according to one or more embodiments of the present disclosure, the processing circuit 200 manages the operation of the chat synchronizer 40 and the chat proxies 30 to allow various users connected to disparate chat platforms 50 to send and receive chat dialogue as if all the users were in the same chat room, as previously described. In addition, processing circuitry 200 is configured to generate virtual chat rooms 60, maintain information in the Host User Profiles 70, communicate with various external platforms 50 to obtain the information for the Host User Profiles 70, and perform the various other functions described above with respect to the chat synchronizer 40. Additionally, processing circuitry 200 is also configured to provide the local chat services associated with the local chat platform, as previously described.

Memory circuitry 202 stores the program code and data needed by the processing circuitry 200 to operate as herein described. Memory circuitry 202 may comprise any combination of volatile and non-volatile memory devices, and may include discrete memory devices as well as internal memory. Program code executed by the processing circuitry 200, such as the code for the chat synchronizer 40, the chat proxies 30, and the local chat platform 220, for example, is typically stored in a non-volatile memory such as a read-only memory (ROM) or flash memory, while temporary data generated during operation of the chat server 20 may be stored in a volatile memory, such as a random access memory (RAM).

The communications interface circuitry 204 comprises an interface for communicating with one or more other remotely located devices, such as the servers that host the chat platforms 50 and various physical media storage devices (e.g., DB) over a communications network. The communications interface circuitry 204 may effect such communications using one or more communication protocols known in the art or that may be developed, such as IMS/SIP, Diameter, HTTP, RTP, RTCP, HTTPs, SRTP, CAP, DCCP, Ethernet, TCP/IP, SONET, ATM, or the like. The communications interface circuitry 204 implements receiver and transmitter functionality appropriate to communication network links (e.g., optical, electrical, and the like), and the transmitter and receiver functions may share circuit components and/or software, or alternatively may be implemented separately.

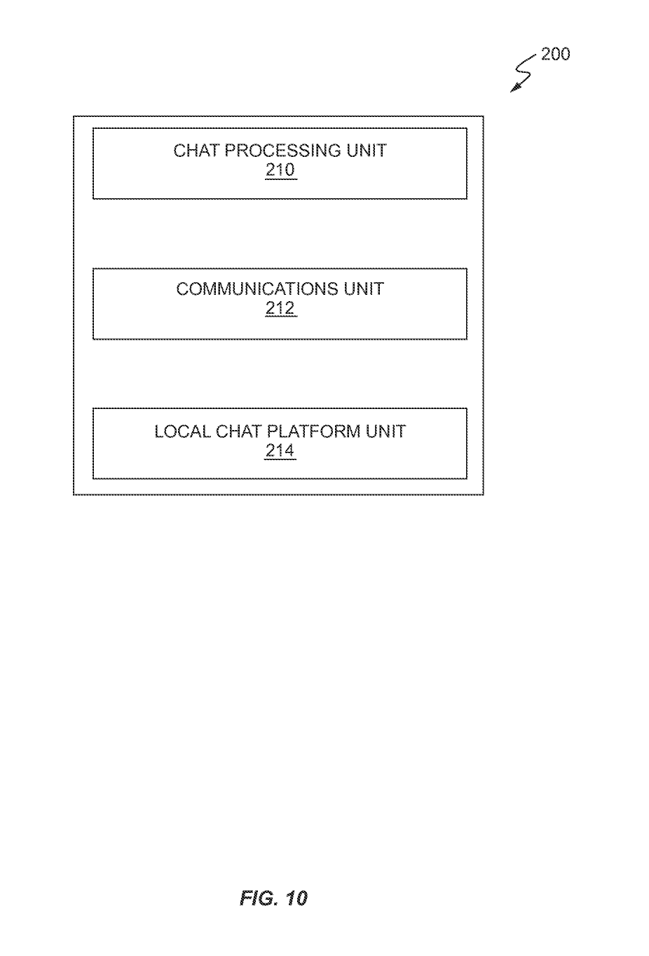

FIG. 10 illustrates the main functional components of exemplary processing circuitry 200. The processing circuitry 200 comprises a chat processing unit 210, a communications unit 212, and local chat platform unit 214. The chat processing unit 210, communications unit 212, and local chat platform unit 214 can be implemented by one or more microprocessors, microcontrollers, hardware, firmware, or a combination thereof.

The primary function of the chat processing unit 210 is to control the functions of the chat synchronizer 40 and the chat proxies 30 to allow various users connected to disparate chat platforms 50 to send and receive chat dialogue as if all the users were in the same chat room, as previously described. Additionally, the chat processing unit 210 is configured to generate virtual chat rooms 60, manage information in the Host User Profiles 70, communicate with the various external platforms 50 to obtain the information for the Host User Profiles 70, communicate chat messages using either a direct or indirect messaging method, and perform the various other functions described above with respect to the chat synchronizer 40 and chat proxies 30.

The communications unit 212 functions to control the communications between chat server 20, the client devices 12, 14, 16, and the external chat platforms 50 over one or more communications networks. Data that is communicated over the communications unit 212 includes, but is not limited to, chat dialogue between users, user and contact information, and parameter data retrieved from the external chat platforms 50. The communications unit 212 performs its functions in response to commands and data received from the chat synchronizer 40 and/or the chat proxies 30.

The local chat platform unit 214 functions to provide the users of client devices 12, 14, 16 with a chat service. In particular, the local chat platform unit 214 operates in conjunction with the chat processing unit 210 to track chat users that are registered on the local chat platform 214, communicate chat messages with other users of the local chat platform using the previously described direct messaging method, log chat dialogue, and the like.

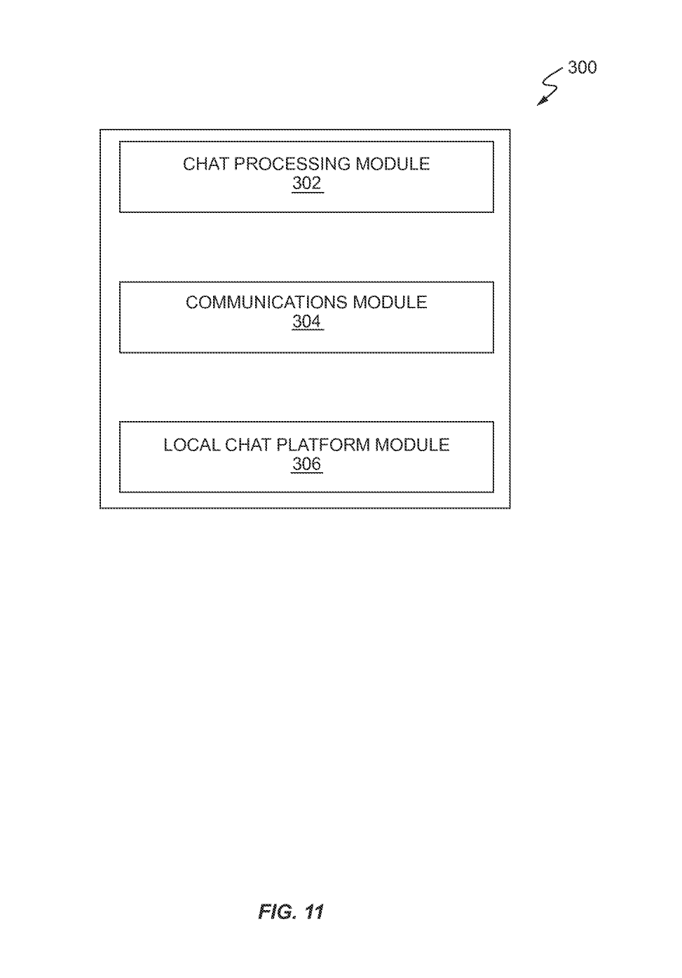

FIG. 11 illustrates an exemplary computer program product 300 embodying computer program code that is executed by the processing circuitry 200. The computer program product 300 may be stored in memory circuitry 202 or other tangible computer readable medium. The computer program product 300 comprises chat processing module 210, a communications module 212, and local chat platform module 214.

When executed by the processing circuitry 200, the chat processing module 302 controls the functions of the chat synchronizer 40 and the chat proxies 30 to allow various users connected to disparate chat platforms 50 to send and receive chat dialogue as if all the users were in the same chat room, as previously described. Additionally, the chat processing module 302 generates virtual chat rooms 60, manages information in the Host User Profiles 70, communicates with the various external platforms 50 to obtain the information for the Host User Profiles 70, communicates chat messages using either a direct or indirect messaging method, and performs the various other functions described above with respect to the chat synchronizer 40 and chat proxies 30.

The communications module 304, when executed by the processing circuitry 200, controls the communications between chat server 20, the client devices 12, 14, 16, and the external chat platforms 50 over one or more communications networks. Data that is communicated by the communications module 304 includes, but is not limited to, chat dialogue between users, user and contact information, and parameter data retrieved from the external chat platforms 50. The communications module 304 performs its functions in response to commands and data received from the chat synchronizer 40 and/or the chat proxies 30

The local chat platform module 306 functions to provide the users of client devices 12, 14, 16 with a chat service. When executed by the processing circuitry 200, the local chat platform module 306 operates in conjunction with the chat processing module 306 to track registered chat users, communicates chat messages with other users of the local chat platform using the previously described direct messaging method, logs chat dialogue, and the like.

Embodiments of the present disclosure synchronizes and shares chat dialogue between clients who are currently logged onto the same and/or different chat networks, without requiring the users to know, a priori, whether another user is or is not on-line. Further, with a system configured according to the present disclosure, the users involved in a chat session perceive the chat as if they are all gathered in the same chat room operating and are utilizing the same chat platform.

The present disclosure may, of course, be carried out in other ways than those specifically set forth herein without departing from essential characteristics of the disclosure. Therefore, the present embodiments are to be considered in all respects as illustrative and not restrictive, and all changes coming within the meaning and equivalency range of the appended claims are intended to be embraced therein

What is claimed is:

1. A method for establishing a chat session between users on disparate chat platforms, the method performed at a chat server computer and comprising:
receiving, from a host user, a request to establish a chat session with a first chat participant;
determining that the host user and the first chat participant are associated with disparate chat platforms;
selecting a chat proxy for the first chat participant, wherein the chat proxy is configured to communicate with the chat platform associated with the first chat participant; and
sending and receiving chat dialogue between the host user and the first chat participant across the disparate chat platforms via the selected chat proxy.

2. The method of claim 1 further comprising modifying a chat message communicated between the host user and the first chat participant via the selected chat proxy to identify which of the host user and the first chat participant sent the chat message.

3. The method of claim 1 wherein the request to establish the chat session further comprises a request to establish the chat session with a second chat participant, the method further comprising:
determining that the host user and the second chat participant are associated with the same chat platform; and
sending and receiving chat dialogue between the host user and the second chat participant via the chat platform associated with the host user and the second chat participant.

4. The method of claim 1 further comprising maintaining a routing table comprising information for routing chat messages between the host user and the chat proxy that was selected for the first chat participant.

5. The method of claim 1 further comprising controlling the chat proxy to log into a user account on the chat platform associated with the first chat participant as the host user.

6. The method of claim 5 further comprising:
controlling the chat proxy to download a contact list from the host user's user account on the chat platform;
detecting anomalous data in the contact list; and
modifying the data in the contact list to correct the anomalous data.

7. The method of claim 1 wherein selecting a chat proxy for the first chat participant comprises selecting the chat proxy from among a plurality of chat proxies, and wherein each of the plurality of chat proxies is configured to communicate with a different chat platform.

8. The method of claim 7 wherein the request to establish the chat session comprises a request to establish the chat session with a plurality of chat participants, each chat participant being associated with a different chat platform.

9. The method of claim 8 further comprising:
identifying the chat platform associated with each chat participant;
selecting a chat proxy from among the plurality of chat proxies for each chat participant associated with a chat platform that is different than the chat platform associated with host user;
generating a virtual chat room to host each of the plurality of chat participants in the chat session; and
sending and receiving chat dialogue between the host user and each of the plurality of chat participants via the chat proxy selected for each chat participant.

10. The method of claim 1 wherein the chat dialogue comprises a plurality of chat messages, and wherein the method further comprises synchronizing the chat messages in chronological order.

11. The method of claim 1 wherein the host user is associated with a host user profile, and wherein the method further comprises:
updating the host user profile to comprise a unique chat room identifier for each chat session that is hosted by the host user; and
updating the host user profile to comprise a unique chat room identifier for each chat session in which the host user is a guest.

12. A chat server for establishing a chat session between users on disparate chat platforms, the chat server comprising:
a communications interface circuit configured to communicate data with one or more client devices and one or more chat platforms; and
a processing circuit configured to:
receive, from a host user, a request to establish a chat session with a first chat participant;
determine that the host user and the first chat participant are associated with disparate chat platforms;
select a chat proxy for the first chat participant, wherein the chat proxy is configured to communicate with the chat platform associated with the first chat participant; and
send and receive chat dialogue between the host user and the first chat participant across the disparate chat platforms via the selected chat proxy.

13. The chat server of claim 12 wherein the processing circuit is further configured to modify a chat message communicated between the host user and the first chat participant via the selected chat proxy to identify which of the host user and the first chat participant sent the chat message.

14. The chat server of claim 12 wherein the processing circuit is further configured to maintain a routing table in a memory circuit accessible to the chat server, wherein the routing table comprises information used for routing the chat dialogue between the host user and the chat proxy selected for the first chat participant.

15. The chat server of claim 12 wherein the host user has a user account on the chat platform associated with the first chat participant, and wherein the processing circuit is further configured to:
control the chat proxy to log into the user account as the host user;
control the chat proxy to download a contact list from the user account;
detect anomalous data in the contact list; and
modify the data in the contact list to correct the anomalous data.

16. The chat server of claim 12 wherein the processing circuit is further configured to select the chat proxy from among a plurality of chat proxies executing at the chat server, and wherein each of the plurality of chat proxies is configured to communicate with a different chat platform.

17. The chat server of claim 16 wherein the request to establish the chat session comprises a request to establish the chat session with a plurality of chat participants, each chat participant being associated with a different chat platform, and wherein the processing circuit is further configured to:
identify the chat platform that is associated with each chat participant;
select a chat proxy from among the plurality of chat proxies for each chat participant associated with a chat platform that is different than the chat platform associated with host user;
generate a virtual chat room to host each of the plurality of chat participants in the chat session; and
send and receive chat dialogue between the host user and each of the plurality of chat participants via the chat proxy selected for each chat participant.

18. The chat server of claim 12 wherein the chat dialogue comprises a plurality of chat messages, and wherein the processing circuit is further configured to synchronize the plurality of chat messages in chronological order.

19. The chat server of claim 12 wherein the host user is associated with a host user profile, and wherein the processing circuit is further configured to:
update the host user profile to comprise a unique chat room identifier for each chat session that is hosted by the host user; and
update the host user profile to comprise a unique chat room identifier for each chat session in which the host user is a guest.

20. A computer-readable medium comprising computer code stored thereon that, when executed by a processing circuit of a chat server, controls the chat server to:
receive, from a host user, a request to establish a chat session with a first chat participant;
determine that the host user and the first chat participant are associated with disparate chat platforms;
select a chat proxy for the first chat participant, wherein the chat proxy is configured to communicate with the chat platform associated with the first chat participant; and
send and receive chat dialogue between the host user and the first chat participant across the disparate chat platforms via the selected chat proxy.
